(19) United States
(12) Patent Application Publication
(10) Pub. No.: US 2024/0318472 A1
(43) Pub. Date: Sep. 26, 2024

(54) CLOSURE LATCH ASSEMBLY WITH LATCH MECHANISM HAVING DEFORMABLE RATCHET CONFIGURATION

(71) Applicant: MAGNA CLOSURES INC., Newmarket (CA)

(72) Inventors: Ann-Margaret MOZOLA, Lakefield (CA); Francesco CUMBO, Pisa (IT); Roman CETNAR, Newmarket (CA)

(21) Appl. No.: 18/602,420

(22) Filed: Mar. 12, 2024

Related U.S. Application Data
(60) Provisional application No. 63/454,375, filed on Mar. 24, 2023.

(51) Int. Cl. E05B 77/06; E05B 85/24

(52) U.S. Cl. CPC E05B 77/06; E05B 85/243

(57) ABSTRACT

A closure latch assembly and system therewith configured for retaining a closure panel of a motor vehicle in a closed position relative to a vehicle body during and upon the latch assembly experiencing a sudden force during a crash condition and prior to the latch assembly having been intentionally actuated to move to an unlatched state.

### CROSS-REFERENCE TO RELATED APPLICATIONS

This application claims the benefit of U.S. Provisional Application Ser. No. 63/454,375, filed Mar. 24, 2023, which is incorporated herein by reference in their entirety.

### FIELD

The present disclosure relates generally to closure latch assemblies for closure panel systems of motor vehicles. More particularly, the present disclosure is directed to a closure latch assembly having a ratchet with a deformation region for predefined deformation of the ratchet during a crash condition to prevent unwanted movement of the ratchet to a striker release position.

### BACKGROUND

This section provides background information related to the present disclosure which is not necessarily prior art.

In view of increased consumer demand for motor vehicles equipped with advanced comfort and convenience features, many current vehicles are now provided with power actuatable latch assemblies operable via passive keyless entry systems to permit powered locking and powered release of the latch assembles without the use of traditional manual entry mechanisms. Although such power actuatable latch assemblies provide desired functionality under normal operating conditions, further advancements are desired to ensure features of the power actuated latch assemblies retain their intended position and functionality upon being impacted, such as in a crash condition, while being economical in manufacture and in use.

In view of the above, there remains a desire to develop alternative power door latch assemblies which address and overcome limitations associated with known power door latch assemblies to provide enhanced functionality upon being impacted, while minimizing cost and complexity associated with such advancements.

### SUMMARY

This section provides a general summary of the present disclosure and is not a comprehensive disclosure of its full scope or all of its features, aspects and objectives.

It is an aspect of the present disclosure to provide a latch assembly for selectively unlatching a vehicle closure panel for desired movement of the closure panel from a closed position to an open or deployed positions relative to a vehicle body when desired and for retaining the closure panel in a closed position relative to the vehicle body when desired.

It is a further aspect of the present disclosure to provide a latch assembly for retaining the closure panel in a closed position relative to the vehicle body upon the power latch assembly experiencing an impact force during a crash condition and prior to the power latch assembly having been intentionally signaled to move to an unlatched state.

In accordance with these and other aspects, a closure latch assembly for a motor vehicle having a vehicle body defining an opening and a closure panel pivotably connected to the vehicle body for swing movement between an open position and a closed position relative to the vehicle body is provided. The closure latch assembly includes a frame plate, a ratchet operably coupled to the frame plate for movement within a pivot plane between at least one striker capture position to retain the closure panel in the closed position and a striker release position to allow the closure panel to be moved to the open position. The closure latch assembly further includes a pawl operably coupled to the frame plate, with the pawl configured for release from a ratchet holding position, whereat the ratchet is maintained in latched engagement with a striker in the striker capture position to maintain the closure panel in the closed position, to the ratchet releasing position, whereat the ratchet is moved out of latched engagement from the striker to allow the closure panel to be moved from the closed position to the open position. The ratchet has a weakened deformation region that causes the ratchet to be plastically deformed in the weakened deformation region during a crash condition, whereupon movement of the plastically deformed ratchet from the at least one striker capture position to the striker releasing position is prevented.

In accordance with another aspect of the disclosure, a first stop member is fixed to the frame plate. The ratchet is configured to move in clearance relation with the first stop member when the ratchet moves from the at least one striker capture position to the striker release position during normal operation. The first stop member is configured for interference with the plastically deformed ratchet to prevent movement of the plastically deformed ratchet from the at least one striker capture position to the striker release position during the crash condition.

In accordance with another aspect of the disclosure, the ratchet can be provided having a roughened outer surface to enhance frictional engagement with the first stop member during the crash condition.

In accordance with another aspect of the disclosure, the roughened outer surface can be formed by a plurality of ribs extending along an outer periphery of the ratchet, with the ribs extending lengthwise from one side of the ratchet to an opposite side of the ratchet.

In accordance with another aspect of the disclosure, the first stop member can be provided having a plurality of ribs configured for meshed, interlocking engagement with the plurality of ribs of the ratchet to increase the friction between ratchet and the first stop member during the crash condition.

In accordance with another aspect of the disclosure, the first stop member has a roughened outer surface facing a roughened outer surface of the ratchet, wherein the roughened outer surfaces of the ratchet and the first stop member engage one another to enhance frictional engagement with the first stop member during the crash condition.

In accordance with another aspect of the disclosure, the at least one striker capture position can include a primary striker capture position and a second striker capture position, wherein the first stop member prevents movement of the plastically deformed ratchet from the primary striker capture position to the striker release position during the crash condition.

In accordance with another aspect of the disclosure, a second stop member can be fixed to the frame plate, with the ratchet being configured to move in clearance relation with the second stop member when the ratchet moves from the secondary striker capture position to the striker release position during normal operation. The second stop member is configured for interference with the plastically deformed ratchet to prevent movement of the plastically deformed ratchet from the secondary striker capture position to the striker release position during the crash condition.

In accordance with another aspect of the disclosure, the second stop member can be formed as a monolithic piece of material with the frame plate.

In accordance with another aspect of the disclosure, the second stop member can be formed as a tab of material bent from an outer periphery of frame plate.

In accordance with another aspect of the disclosure, the ratchet has a ratchet pin opening configured for receipt of a ratchet pin therethrough, about which the ratchet pivots during normal operation, and a striker slot in which the striker is received while the ratchet is in the at least one striker capture positions, the striker slot being open to the ratchet pin opening.

In accordance with another aspect of the disclosure, a first ratchet guide member can be provided extending laterally from the first stop member, the first ratchet guide member inhibiting the ratchet from moving out of the pivot plane during normal use and during the crash condition.

In accordance with another aspect of the disclosure, a second ratchet guide member can be provided extending laterally from the second stop member, the second ratchet guide member inhibiting the ratchet from moving out of the pivot plane during normal use and during the crash condition.

In accordance with another aspect of the disclosure, the ratchet has a striker slot in which the striker is received while the ratchet is in the at least one striker capture position, the roughened outer surface of the ratchet being located between the weakened outer surface and the striker slot.

In accordance with a further aspect, a method of preventing a ratchet of a closure latch assembly of a motor vehicle closure panel from inadvertently moving about a pivot plane from at least one striker capture position to a striker release position during a crash condition is provided. The method includes configuring the ratchet having a weakened deformation region that causes the ratchet to be plastically deformed locally in the weakened deformation region during the crash condition, whereupon movement of the ratchet from the at least one striker capture position to the striker releasing position is prevented.

The method further includes providing a first stop member fixed to a frame plate of the closure latch assembly, wherein the ratchet is configured to move in clearance relation with the first stop member when the ratchet moves in the pivot plane from the at least one striker capture position to the striker release position during normal operation. The first stop member is configured for interference with the plastically deformed ratchet to prevent movement of the plastically deformed ratchet from the at least one striker capture position to the striker release position during the crash condition.

The method can further include providing at least one or both of the ratchet and the first stop member having a roughened outer surface to enhance frictional engagement between the ratchet and the first stop member during the crash condition.

The method can further include providing the at least one striker capture position including a primary striker capture position and a second striker capture position, wherein the first stop member prevents movement of the plastically deformed ratchet from the primary striker capture position to the striker release position during the crash condition, and further including providing a second stop member fixed to the frame plate. Further, configuring the ratchet to move in clearance relation with the second stop member when the ratchet moves from the secondary striker capture position to the striker release position during normal operation, and configuring the second stop member for interference with the plastically deformed ratchet to prevent movement of the plastically deformed ratchet from the secondary striker capture position to the striker release position during the crash condition.

The method can further include providing at least one of the ratchet and the second stop member having a roughened outer surface to enhance frictional engagement between the ratchet and the second stop member during the crash condition.

The method can further include providing a ratchet guide member extending laterally from at least one or both of the first stop member and the second stop member, the at least one ratchet guide member inhibiting the ratchet from moving out of the pivot plane.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1A illustrates an example motor vehicle equipped with a power door actuation system situated between a front passenger swing door and a vehicle body and which is configured to include a power latch assembly in accordance with one aspect of the disclosure;

FIG. 1B is a partial perspective view showing the power latch assembly installed in a passenger swing door associated with the vehicle shown in FIG. 1A;

FIG. 1C illustrates an example embodiment of a power latch assembly in accordance with one aspect of the disclosure with various components removed for clarity purposes only;

FIG. 2 is a diagrammatic view of the front passenger swing door shown in FIG. 1A, with various components removed for clarity purposes only, in relation to a portion of the vehicle body and which is equipped with the power door actuation system including a power latch assembly of the present disclosure;

FIG. 3 is a front side view of a closure latch assembly in accordance with an aspect of the disclosure shown with a back plate removed for clarity purposes only, with a ratchet of the closure latch assembly shown in a primary striker capture position;

FIG. 3A is a perspective view of a closure latch assembly in accordance with another aspect of the disclosure shown with a ratchet of the closure latch assembly shown in a primary striker capture position;

FIG. 4 is a view of the closure latch assembly of FIG. 3 with the ratchet of the closure latch assembly shown in a secondary striker capture position;

FIG. 4A is a view of the closure latch assembly of FIG. 3A with the ratchet of the closure latch assembly shown in a secondary striker capture position;

FIG. 5 is a view of the closure latch assembly of FIG. 3 with the ratchet of the closure latch assembly shown in a striker release position;

FIG. 6 is a view of the closure latch assembly of FIG. 3 with the ratchet of the closure latch assembly shown deformed from the primary striker capture position to a primary emergency capture position during a crash condition;

FIG. 7 is a view of the closure latch assembly of FIG. 4 with the ratchet of the closure latch assembly shown deformed from the secondary striker capture position to a secondary emergency capture position during a crash condition;

FIG. 8 is a view similar to FIG. 3 of a closure latch assembly in accordance with another aspect of the disclosure shown with a ratchet of the closure latch assembly shown in a primary striker capture position; and

FIG. 9 is flow diagram illustrating a method of preventing a ratchet of a latch assembly of a motor vehicle closure panel from inadvertently moving from at least one striker capture position to a striker release position during a crash condition.

### DETAILED DESCRIPTION OF EXAMPLE EMBODIMENTS

In general, example embodiments of a power door actuation system including a power latch assembly constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

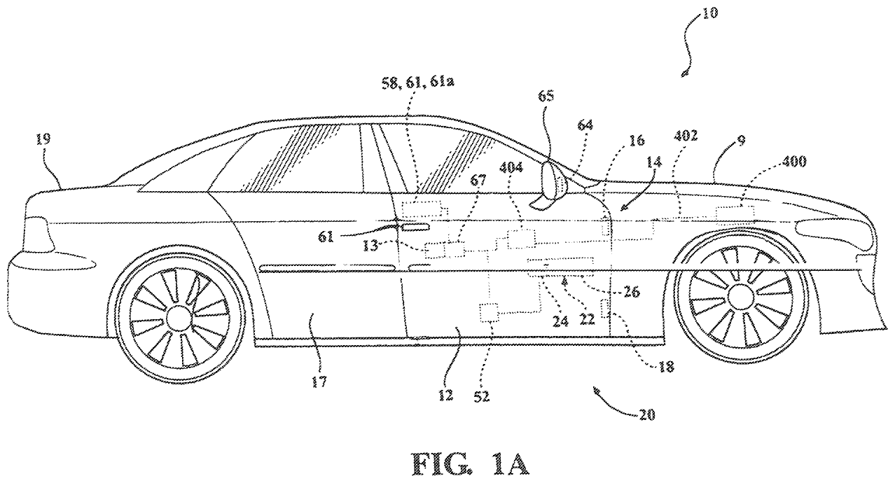

Referring initially to FIG. 1A, an example motor vehicle 10 is shown to include a first closure panel, shown by way of example and without limitation as a front passenger swing door, referred to hereafter simply as swing door or door 12, pivotally mounted to a vehicle body 14 via an upper door hinge 16 and a lower door hinge 18 which are shown in dashed lines. In accordance with the present disclosure, a power door actuation system 20 is associated with the swing door 12, and in accordance with a preferred configuration, power door actuation system 20 includes a power latch assembly 13, a vehicle door electric control unit (ECU) 52, and can also be configured with a power-operated swing door actuator 22 secured within an internal cavity of passenger door 12 for coordinated control of the opening and closing of the door 12, if desired. The motor vehicle 10 illustrated in FIG. 1A may be provided including mechanically actuatable outside vehicle door handles 61 and inside door handles 61a on the vehicle door 12, an example of which is described herein below and illustrated in FIGS. 1A-1C. In accordance with an aspect of the disclosure, the power latch assembly 13 is configured to retain the swing door 12 in a closed position relative to the vehicle body 14 upon the vehicle body 14 and power latch assembly 13 experiencing an influence, such as for example an impact force during a crash condition, prior to the power latch assembly 13 having been intentionally signaled to move to an unlatched state. Accordingly, the power latch assembly 13 resists inadvertent, unintended opening of the swing door 12 upon experiencing an impact force.

While power door actuation system 20 is only shown in FIG. 1A in association with front passenger door 12, those skilled in the art will recognize that the power door actuation system 20 and power latch assembly 13 can also be associated with any other door, such as rear passenger doors 17 as shown in FIG. 1B, or also be associated with other closure panels, such as a liftgate (not shown), a hood 9, or a decklid 19. Also, while the door 12 is illustrated herein as being pivotally mounted to the vehicle body 14 for rotation relative to a vertical or generally vertical axis extending through upper and lower hinges 16, 18, it may be configured for rotation about a horizontal axis as would be the case for a liftgate, or other offset (oblique) axis, or the like. For greater clarity, the vehicle body 14 is intended to include the ‘non-moving’ structural elements of the vehicle 10, such as the vehicle frame, structural support pillars and members, and body panels.

Referring to FIGS. 1B and 1C, shown is a non-limiting embodiment of power latch assembly 13 for vehicle doors 12, 17 of vehicle 10. Power latch assembly 13 can be positioned on vehicle door(s) 12, 17 and arranged in a suitable orientation to engage and retain a striker 37, mounted on vehicle body 14, when door 12, 17 is closed. Power latch assembly 13 includes a latch mechanism having a ratchet 21 and a release chain component, such as a pawl 23, a latch release mechanism having a pawl release lever 25, an inside door release mechanism having an inside release lever 27, a power release actuator 29 for controlling powered actuation of the latch release mechanism, and a power lock actuator 31 having a lock mechanism 33 and an electric lock motor 35, which are illustratively shown for forming a release chain for holding and/or releasing the ratchet 21, as now described.

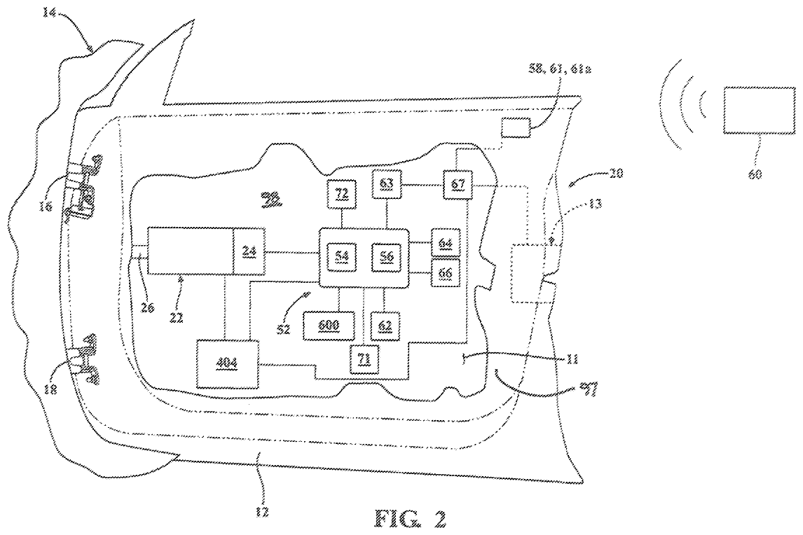

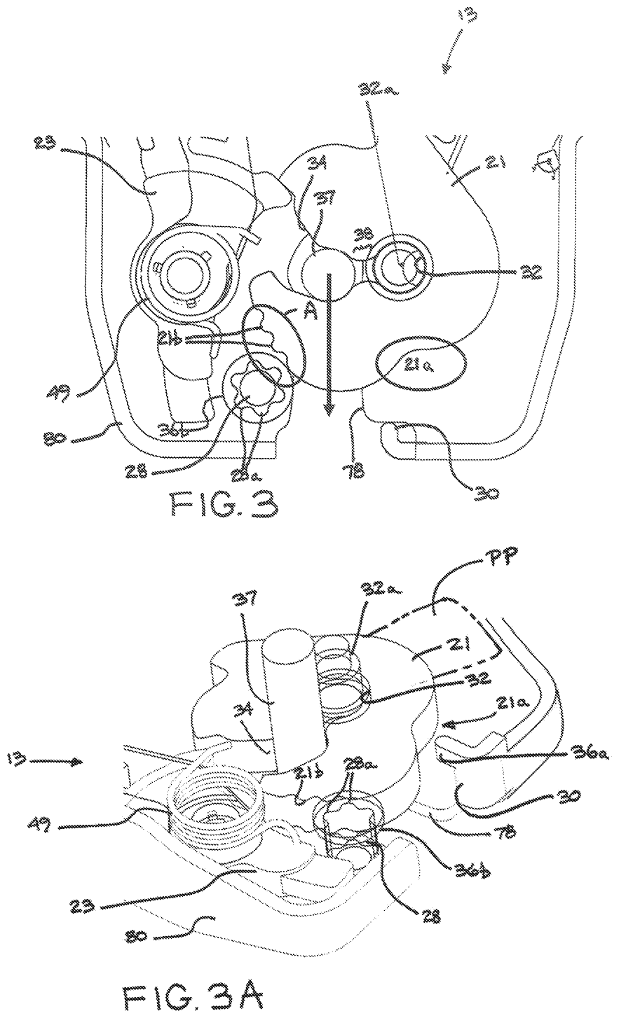

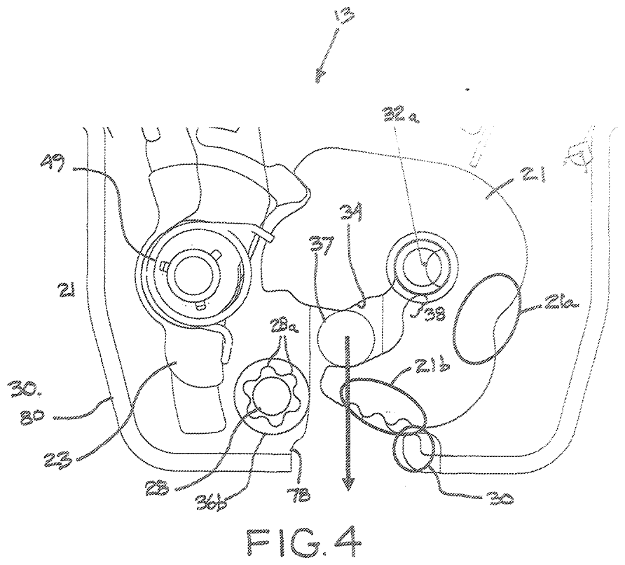

Ratchet 21 is moveable between two striker capture positions including a primary or fully closed position (shown in FIG. 3) and secondary or partially closed position (FIG. 4) whereat ratchet 21 retains striker 37 against being fully released. Ratchet 21 is also moveable to a striker release position (FIG. 5) whereat ratchet 21 permits release of striker 37 from a fishmouth 78 provided in a frame plate 80 of closure latch assembly 13 housing, which can also include a back plate, also referred to as cover (not shown). A ratchet biasing member 47, such as a spring, is provided to normally bias ratchet 21 toward its striker release position. Pawl 23 is movable between a ratchet holding position, whereat pawl 23 holds ratchet 21 in its closed, striker capture position(s), primary and secondary, wherein door 12 is maintained in a closed state, also referred to as closed position, thereby being restrained against being fully opened, and a ratchet releasing position, whereat pawl 23 permits ratchet 21 to move to its open, striker release position under the bias imparted by ratchet biasing member 47, wherein door 12 can be moved to a fully open state, also referred to as open position. A pawl/pawl release lever biasing member 49, such as a suitable spring, is provided to normally bias pawl 23 toward its ratchet holding position.

Pawl release lever 25 is operatively connected to pawl 23, either directly or indirectly, and is movable between a pawl release position, whereat pawl release lever 25 moves pawl 23 to its ratchet releasing position, and a home position, whereat pawl release lever 25 permits pawl 23 to be in its ratchet holding position. A release lever biasing member, such as a spring 49, is provided to normally bias pawl release lever 25 toward its home position. Pawl release lever 25 can be moved to its pawl release position by several components, such as, for example, by power release actuator 29 and by inside door release lever 27. Power release actuator 29 includes a power release motor 51 having an output shaft 53, a power release worm gear 55 mounted or provided on output shaft 53, and a gear member, referred to hereafter as power release gear 57. Power release gear 57 has gear teeth 57′ configured in meshed engagement with gear teeth, shown as a spiral or helical gear tooth 55′, by way of example and without limitation, of power release worm gear 55. A power release cam 59 is connected for rotation with power release gear 57 and is rotatable between a pawl release range of positions and a pawl capture position, also referred to as pawl non-release range of positions. In FIG. 1C power release cam 59 is located in a position that is within the pawl non-release range, whereat ratchet 21 is maintained in the striker capture position. Power release gear 57 is selectively driven rotatably by power release worm gear 55 for driving power release cam 59, which, in turn, directly or indirectly (operatively), such as via engagement with an intermediate release lever (not shown), drives pawl release lever 25 from its home position into its pawl release position, as will be understood by a person possessing ordinary skill in the art of latches.

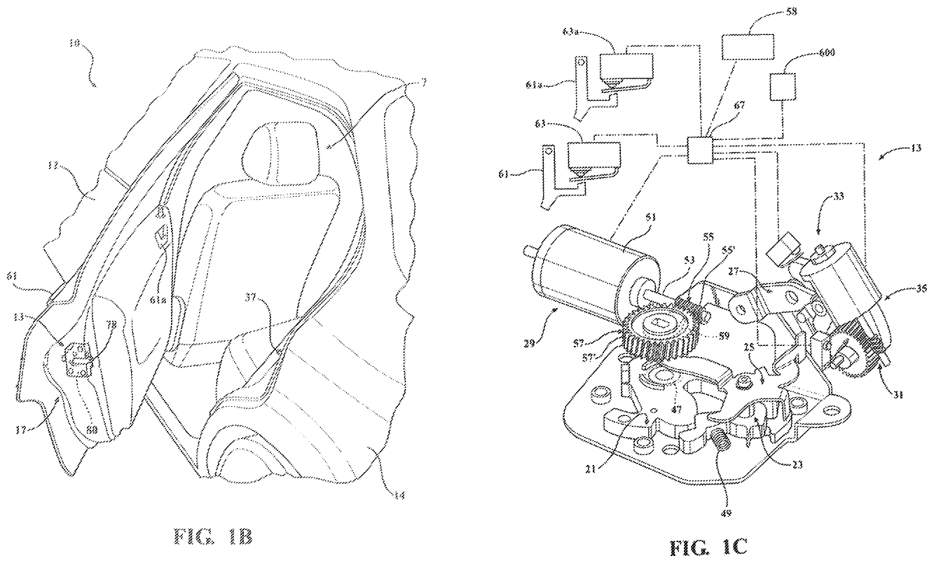

Power release actuator 29 can be used as part of a conventional passive keyless entry feature. When a person approaches vehicle 10 with an electronic key fob 60 (shown schematically in FIG. 2) and actuates the outside door handle 61, for example, sensing both the presence of key fob 60 and that door handle 61 has been actuated (e.g. via communication between a switch 63 (FIG. 1C) and a latch electronic control unit (ECU) shown at 67 (FIG. 1C) that at least partially controls the operation of closure latch assembly 13). In turn, latch ECU 67 signals and actuates power release actuator 29 to cause the latch release mechanism, via driven rotation of power release gear 57 and power release cam 59 in an unlocking direction, to pivot pawl 23 to its ratchet releasing position to release ratchet 21 to move under the bias of ratchet biasing member 47 to its striker release position and shift closure latch assembly 13 into an unlatched operating state so as to facilitate subsequent opening of door 12. Power release actuator 29 can be alternatively activated as part of a proximity sensor based entry feature (radar based proximity detection for example), for example when a person approaches vehicle 10 with an electronic key fob 60 (FIG. 2) and actuates a proximity sensor 58, such as a capacitive sensor, or other touch/touchless based sensor (based on a recognition of the proximity of an object, such as the touch/swipe/hover/gesture or a hand or finger, or the like), (e.g. via communication between the proximity sensor 58 (FIG. 1C) and latch ECU 67 (FIG. 1C) that at least partially controls the operation of closure latch assembly 13). In turn, latch ECU 67 signals power release actuator 29 to cause the latch release mechanism to release the latch mechanism and shift closure latch assembly 13 into an unlatched operating state to facilitate subsequent opening of door 12. Also, power release actuator 29 can be used in coordinated operation with power-operated swing door actuator 22. Further yet, outside door handle 61 may be configured for mechanical actuation of closure latch assembly 13 to facilitate opening the door 12, as will be understood by a person possessing ordinary skill in the art of latches, such as, by way of example and without limitation, during power interruption and/or upon experiencing a crash condition, as discussed further below.

Power-operated swing door actuator 22 can be mounted in door 12 and located near door hinges 16, 18 to provide for full or partial open/close movement of swing door 12 under actuation; to provide an infinite door check function; and to provide manual override (via a slip clutch) of power-operated swing door actuator 22, as desired. Power operated swing door actuator 22 can function to automatically swing door 12 about its pivot axis between its open and closed positions. Typically, power-operated swing door actuator 22 can include a power-operated device such as, for example, an electric motor 24 and a rotary-to-linear conversion device that are operable for converting the rotary output of the electric motor 24 into translational movement of an extensible member 26. In many power door actuation arrangements, the electric motor 24 and the conversion device are mounted to swing door 12 and a distal end of an extensible member 26 is fixedly secured to vehicle body 14 proximate the door hinges 16, 18. Driven rotation of the electric motor 24 causes translational movement of the extensible component 26, which, in turn, controls pivotal movement of passenger door 12 relative to vehicle body 14. As also shown, the ECU 52 is in communication with electric motor 24 for providing electric control signals thereto for control thereof. As shown in FIG. 2, ECU 52 can include hardware such as a microprocessor 54 and a memory 56 having executable computer readable instructions stored thereon for implementing the control logic stored as a set of computer readable instructions in memory 56 for operating the power door actuation system 20.

Now referring back to FIG. 1B and 1C, the door 12 may have a conventional opening lever or inside door handle 61a located on an interior facing side of the door 12 facing the inside of the passenger compartment 7 for opening the door 12 (e.g. including unlocking and opening the closure latch assembly 13, as well as commanding operation of the power-operated swing door actuator 22). This opening lever or inside door handle 61a can trigger a switch 63a connected operably to the latch ECU 67 such that, when the switch 63a is actuated, the latch ECU 67 signals and facilitates power latch assembly 13 being activated. Subsequently, the latch ECU 67 may facilitate that the power-operated swing door actuator 22 is activated (i.e. the extension member 26 is deployed or extended) to continue the automatic opening of the door 12. In the alternative, the power-operated swing door actuator 22 may be powered on at a point before the final presentment position is reached so as to provide a seamless transition between the two stages of door opening (i.e. both motors are overlapping in operation for a short time period). Alternatively, the latch ECU 67 may facilitate that the power-operated swing door actuator 22 is operated as a door check (i.e. the extension member 26 is deployed or extended and maintained at such a deployed or extended condition) until the user manually takes control of the door 12 to further open it to a fully opened position. Further yet, inside door handle 61a may be configured for mechanical actuation of closure latch assembly 13, via intervening mechanical mechanism(s), to facilitate opening the door 12, as will be understood by a person possessing ordinary skill in the art of latches, such as during power interruption and/or upon experiencing a crash condition, as discussed further below.

Now referring back to FIG. 1A, the power door actuation system 20 and the closure latch assembly 13 are electrically connected to a main power source 400 of the motor vehicle 10, for example a main battery providing a battery voltage V_{batt} of 12 V, through an electrical connection element 402, for example a power cable (the main power source 400 may equally include a different source of electrical energy within the motor vehicle 10, for example an alternator). The electronic latch ECU 67 and/or swing door ECU 52 are also coupled to the main power source 400 of the motor vehicle 10, so as to receive the battery voltage V_{batt}; the electronic latch ECU 67 and/or swing door ECU 52 are thus able to check if the value of the battery voltage V_{batt} decreases below a predetermined threshold value, to promptly determine if an emergency condition (when a backup energy source may be needed) occurs.

As shown in the schematic block diagram of FIG. 1A and FIG. 2, a backup energy source 404, which may be integrated forming part of an electronic control circuit of the electronic latch ECU 67 and/or swing door ECU 52, or may be separate therefrom, is configured to supply electrical energy to the power door actuation system 20 and/or the power latch assembly 13, and to the same electronic control circuit of the electronic latch ECU 67 and/or swing door ECU 52, in case of failure or interruption of the main power supply from the main power source 400 of the motor vehicle 10.

In an illustrative example, the backup energy source 404 includes a group of low voltage supercapacitors (not shown) as an energy supply unit (or energy tank) to provide power backup to the power door actuation system 20 and/or the closure latch assembly 13, even in case of power failures. Supercapacitors may include electrolytic double layer capacitors, pseudocapacitors or a combination thereof. Other electronic components and interconnections of a backup energy source 404, such as a boost module to increase the voltage from the backup energy source 404 to an actuator, such as the power-operated swing door actuator for example, are disclosed in co-owned patent application US2015/0330116, which is incorporated herein by way of reference in its entirety.

Now referring back to FIG. 2, illustrated are one or more sensors 71 communicating with swing door ECU 52 for providing requisite information. It is recognized that sensors 71 can be any number of sensor types (e.g. Hall sensor, presence sensors such as anti-pinch strips, capacitive, ultrasonic, radar, mechanical switches, location sensors, etc.). Although not expressly illustrated, electric motor 24 of power-operated swing door actuator 22 can include sensors for monitoring a position of vehicle door 12 during movement between its open and closed positions. As is also schematically shown in FIG. 2, swing door ECU 52 can be in communication with remote key fob 60 via a fob trans-receiver module 600 or internal/external handle switch 63, 63a, or proximity sensor 58 for receiving a request from a user to open or close vehicle door 12. Put another way, swing door ECU 52 receives a command signal from either remote key fob 60 and/or internal/external handle switch 63, 63a, and/or proximity sensor 58 to initiate an opening or closing of vehicle door 12. It is also recognized that a body control module 72 (having memory with instructions for execution on a computer processor) mounted in vehicle body 14 of vehicle 10 can send the open or close request to swing door ECU 52 and electronic latch ECU 67.

Swing door ECU 52 can also receive an additional input from a proximity sensor 64 (e.g. ultrasonic or radar) positioned on a portion of swing door 12, such as on a door mirror 65, or the like, as shown in FIG. 1A. Proximity sensor 64 assesses if an obstacle, such as another car, tree, post, or otherwise, is near or in close proximity to vehicle door 12. If such an obstacle is present, proximity sensor 64 will send a signal to swing door ECU 52, and swing door ECU 52 will proceed to turn off electric motor 24 to stop movement of swing door 12, and thus prevent vehicle door 12 from hitting the obstacle.

A non-limiting embodiment of closure latch assembly 13 will now be further described with reference to FIGS. 3-7, wherein various components have been removed for clarity only and to better illustrate aspects discussed hereafter. The closure latch assembly 13 includes the frame plate 80, configured to support various components therein and/or thereon, such as, by way of example and without limitation, power release actuator 29; power release gear 57; ratchet 21, and pawl 23. Further, a back plate (not shown), can also be provided to facilitate supporting the aforementioned features.

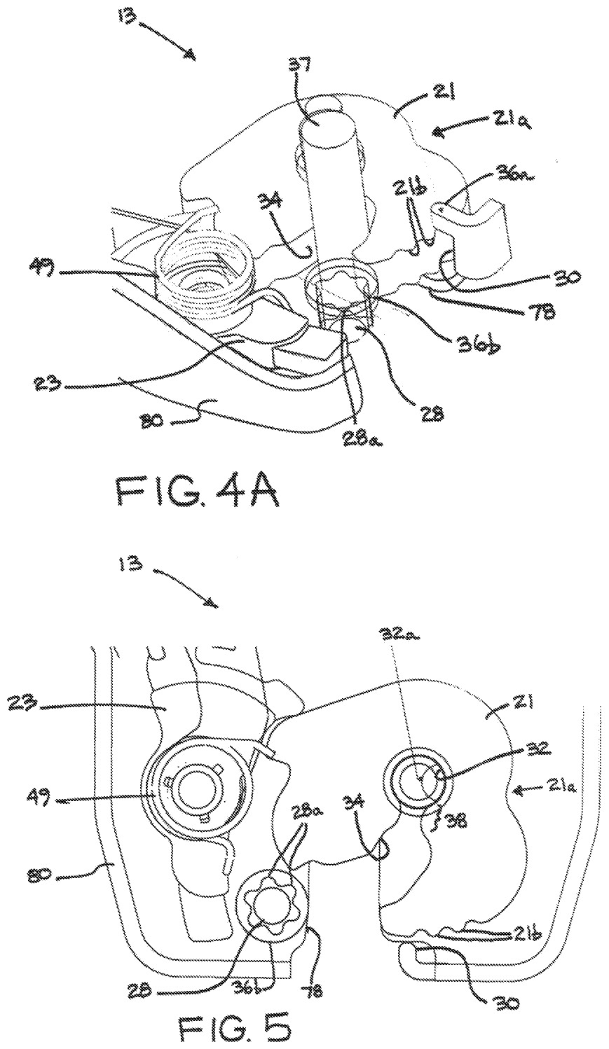

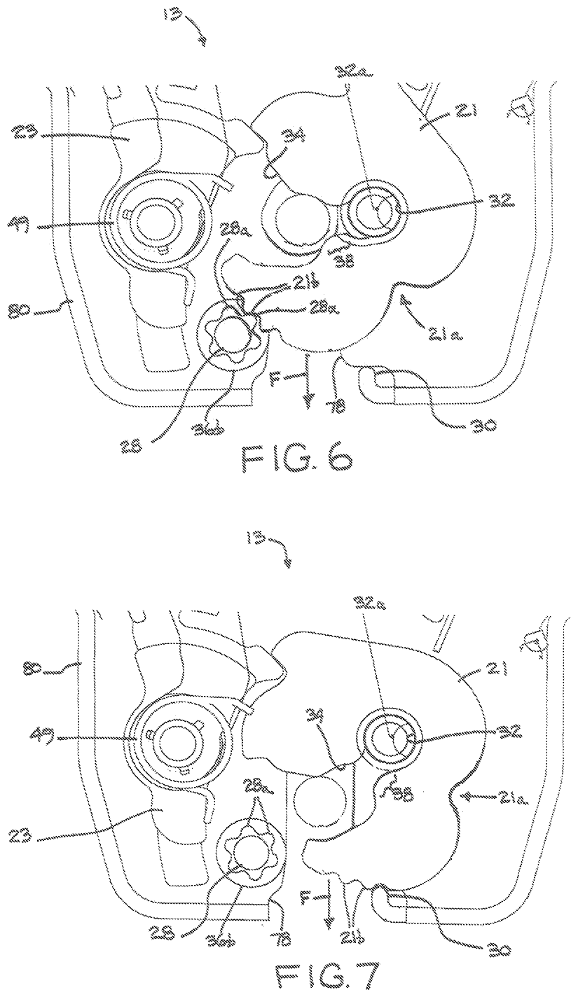

The ratchet 21 has a weakened deformation region 21a that causes the ratchet 21 to be intentionally elastically and/or plastically deformed in the localized area of the weakened deformation region 21a when experiencing an abnormal force F (FIGS. 6 and 7) acting on the ratchet 21 toward a release direction, such as during a crash condition. Movement of the elastically and/or plastically deformed ratchet 21 from the primary and secondary striker capture positions to the striker releasing position is prevented.

To facilitate preventing movement of the deformed ratchet 21 to the striker release position, a first stop member 28 is fixed to the frame plate 80 and/or the back plate. The ratchet 21 is configured to move in clearance relation with the first stop member 28 when the ratchet 21 moves from the primary and secondary striker capture positions to the striker release position during normal operation (FIGS. 3 and 4). However, the first stop member 28 is configured for interference with the elastically and/or plastically deformed ratchet 21 to prevent movement of the elastically and/or plastically deformed ratchet 21 from the primary striker capture position to the striker release position upon application of the force F, such as during a crash condition (FIG. 6).

The first stop member 28 is shown as a protrusion or pin extending laterally outwardly from a sidewall of the frame plate 80. The pin 28, in the non-limiting embodiment illustrated, has a roughened outer surface, shown as having a plurality of ridges or ribs 28a extending about the pin 28, wherein the ribs 28a extend lengthwise along the pin, much like spur gear teeth of a spur gear, by way of example and without limitation. The pin 28 can be fixed to the frame plate 80 via any desired fixation mechanism, such as in a riveting operation, cold-forming, and/or welding operation, by way of example and without limitation.

The ratchet 21 has a roughened outer surface 21a facing the pin 28, with roughened outer surface 21a shown as having a plurality of ridges or ribs 21b extending along an outer periphery of the ratchet 21. The ribs 21b are configured in facing relation with the ribs 28a of pin 28, wherein the ribs 21b are arranged in spaced relation from the ribs 28a of pin 28 during normal operation of closure latch assembly 13, such that the ribs 21b, 28a do not contact each other during movement of ratchet 21 between the primary striker capture position and the striker release position. However, while ratchet 21 is in the primary striker capture position, and upon experiencing force F, ratchet 21 is deformed, such as elastically or plastically deformed, such that ribs 21b are brought into engagement with ribs 28a of pin 28, with the ribs 21b, 28a being configured for meshed engagement with one another to increase the friction between ratchet 21 and pin 28, thereby preventing movement of ratchet 21 from the primary striker capture position toward the striker release position.

To further facilitate preventing movement of the deformed ratchet 21 to the striker release position, a second stop member 30 is fixed to the frame plate 80. The ratchet 21 is configured to move in clearance relation with the second stop member 30 when the ratchet 21 moves from the primary and secondary striker capture positions to the striker release position during normal operation (FIG. 4). However, the second stop member 30 is configured for interference with the plastically deformed ratchet 21 to prevent movement of the plastically deformed ratchet 21 from the secondary striker capture position to the striker release position during the crash condition (FIG. 7). As such, if the ratchet 21 is in the secondary striker capture position upon experiencing the force F, ratchet 21 is prevented from unintentional release to the striker release position via engagement of ribs 21b with second stop member 30. Second stop member 30 can be fixed to frame plate 80, such as discussed above for first stop member 21b, and is shown, by way of example and without limitation, as being formed as a monolithic piece of material with the frame plate 80, and in the non-limiting embodiment illustrated, the second stop member 30 is shown as a tab of the frame plate material bent inwardly from an outer periphery of frame plate 80. Tab 30 is configured for engagement with ribs 21b upon force F being applied to ratchet 21, as discussed above.

In accordance with a further aspect, closure latch assembly 13 can include a first ratchet guide member 36a (FIGS. 3A and 4A) configured to keep ratchet 21 from deflecting axially (relative to a pivot axis) out of a pivot plane PP (FIG. 3A) in which ratchet 21 is intended to pivot while pivoting between the primary and secondary striker capture positions and the striker release position. First ratchet guide member 36a is shown, by way of example and without limitation, as being an extension from second stop member 30. Ratchet 21 is configured to pivot in clearance relation with first ratchet guide member 36a in normal use, wherein a side surface of ratchet 21, if forcibly moved laterally from the pivot plane PP, such as while experiencing force F from the sudden impact, can be brought into engagement with first ratchet guide member 36a, wherein first ratchet guide member 36 prevents movement of ratchet 21 out of the pivot plane PP. As such, ratchet 21 is prevented from unwanted lateral deflection, and thus, is assured of remaining in its intended pivot plane PP, thereby causing ribs 21b to properly engage ribs 28a or tab 30 to prevent unintended movement of ratchet 21 to its striker release position. A second ratchet guide member 36b (best illustrated in FIGS. 3A and 4A) can be provided as a flange or enlarged, radially extending head at an end of first stop member 28, with second ratchet guide member 36b functioning in the same manner as discussed for first ratchet guide member 36a. Accordingly, aside from maintaining ratchet 21 in the intended pivot plane PP during normal operation, it is to be recognized that first and second ratchet guide members 36a, 36b, respectively, function to maintain ratchet 21 in its functional pivot plane PP during a crash condition, thereby assuring first and second stop members 28, 30 remain frictionally engaged with the roughened outer surface 21a, as intended and described above.

In accordance with a further aspect of the disclosure, ratchet 21 has a ratchet pin opening 32 configured for receipt of a ratchet pin 32a therethrough, about which ratchet 21 pivots during normal operation. Ratchet 21 also has a striker slot 34 in which the striker 37 is received and captured while ratchet 21 is in the primary and secondary striker capture positions. The roughened outer surface 21b is located between the weakened outer surface 21a and the striker slot 34, as this is the region of the ratchet 21 that engages the first and second stop members 28, 30, depending on the originating position of the ratchet 21 during the crash condition, as discussed above. The striker slot 34 is open to the ratchet pin opening 32 via a reduced width (necked down) channel 38, and thus, striker 37 is moved into relatively closed relation to ratchet pin 32a compared to a scenario where a ratchet slot is not open to a ratchet pin opening. Accordingly, the moment arm between the ratchet pin 32a and the striker 37 is minimized, thereby reducing the torque (effort) required to cinch ratchet 21 in a cinching operation, without compromising the strength of ratchet 21.

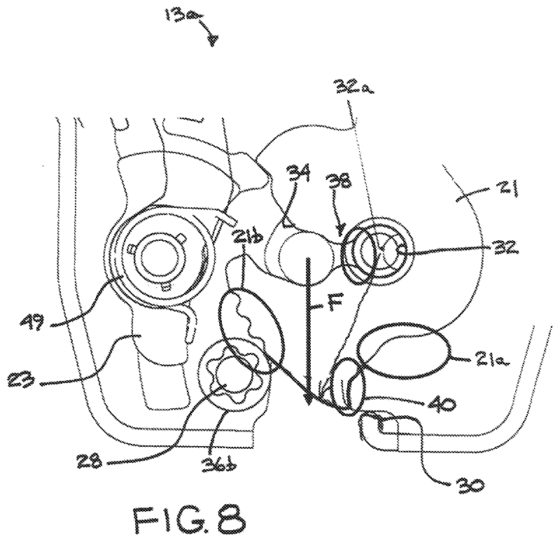

In FIG. 8, an alternate embodiment of a closure latch assembly 13a is illustrated. Closure latch assembly 13a functions similarly as discussed above for closure latch assembly 13; however, in addition to ribs 21b and first stop member 28, or in lieu thereof, ratchet 21 can include a protrusion 40 configured for engagement with second stop member 30 (tab 80a) of frame plate. Protrusion 40 is configured for movement in clearance relation with frame plate 80 during normal use, and for interference with a feature of frame plate 80, such as second stop member 30, upon ratchet 21 being deformed by force F.

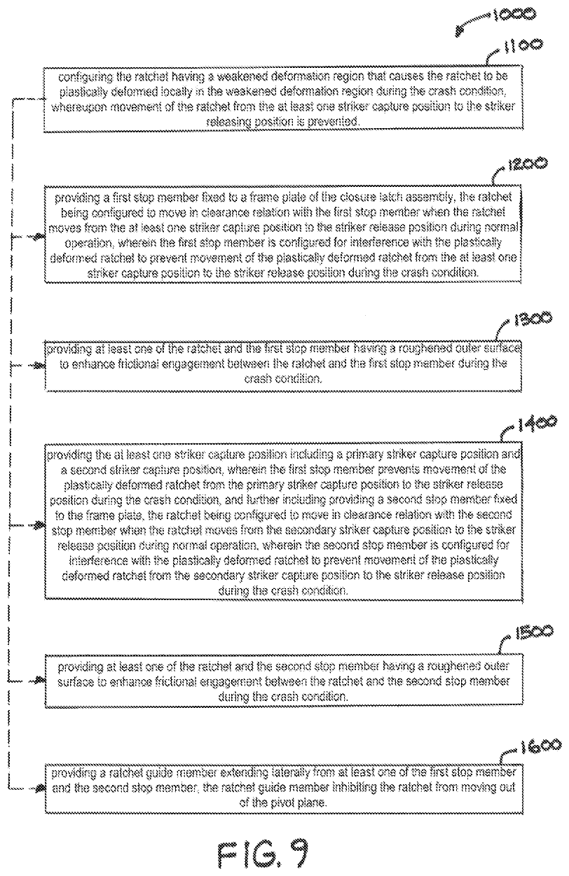

In FIG. 9 a method 1000 of preventing a ratchet 21 of a closure latch assembly 13 of a motor vehicle closure panel 12 from inadvertently moving about a pivot plane PP from at least one striker capture position to a striker release position during a crash condition is provided. The method 1000 includes a step 1100 of configuring the ratchet 21 having a weakened deformation region 21a that causes the ratchet 21 to be plastically deformed locally in the weakened deformation region 21a during the crash condition, whereupon movement of the ratchet 21 from the at least one striker capture position to the striker releasing position is prevented.

The method 1000 further includes a step 1200 of providing a first stop member 28 fixed to a frame plate 80 of the closure latch assembly 13, wherein the ratchet 21 is configured to move in clearance relation with the first stop member 28 when the ratchet 21 moves from the at least one striker capture position to the striker release position during normal operation. The first stop member 28 is configured for interference with the plastically deformed ratchet 21 to prevent movement of the plastically deformed ratchet 21 from the at least one striker capture position to the striker release position during the crash condition.

The method 1000 can further include a step 1300 of providing at least one or both of the ratchet 21 and the first stop member 28 having a roughened outer surface to enhance frictional engagement between the ratchet 21 and the first stop member 28 during the crash condition.

The method 1000 can further include a step 1400 of providing the at least one striker capture position including a primary striker capture position and a second striker capture position, wherein the first stop member 28 prevents movement of the plastically deformed ratchet 21 from the primary striker capture position to the striker release position during the crash condition, and further including providing a second stop member 30 fixed to the frame plate 80. Further, configuring the ratchet 21 to move in clearance relation with the second stop member 30 when the ratchet 21 moves from the secondary striker capture position to the striker release position during normal operation, and configuring the second stop member 30 for interference with the plastically deformed ratchet 21 to prevent movement of the plastically deformed ratchet 21 from the secondary striker capture position to the striker release position during the crash condition.

The method 1000 can further include a step 1500 of providing at least one of the ratchet 21 and the second stop member 30 having a roughened outer surface to enhance frictional engagement between the ratchet 21 and the second stop member 28 during the crash condition.

The method 1000 can further include a step 1600 of providing a ratchet guide member (36a, 36b) extending laterally from at least one or both of the first stop member 28 and the second stop member 30, the at least one ratchet guide member 36a, 36b inhibiting the ratchet 21 from moving out of the pivot plane PP.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly for a motor vehicle having a vehicle body defining an opening and a closure panel pivotably connected to the vehicle body for swing movement between an open position and a closed position relative to the vehicle body, comprising:
a frame plate;
a ratchet operably coupled to said frame plate for movement within a pivot plane between at least one striker capture position to retain the closure panel in the closed position and a striker release position to allow the closure panel to be moved to the open position;
a pawl operably coupled to said frame plate and configured for release from a ratchet holding position, whereat said ratchet is maintained in latched engagement with a striker in the striker capture position to maintain the closure panel in the closed position, to the ratchet releasing position, whereat said ratchet is moved out of latched engagement from the striker to allow the closure panel to be moved from the closed position to the open position,
wherein the ratchet has a weakened deformation region that causes the ratchet to be plastically deformed in the weakened deformation region during a crash condition, whereupon movement of the plastically deformed ratchet from the at least one striker capture position to the striker releasing position is prevented.

2. The closure latch assembly of claim 1, further including a first stop member fixed to said frame plate, said ratchet being configured to move in clearance relation with said first stop member when said ratchet moves from the at least one striker capture position to the striker release position during normal operation, wherein said first stop member is configured for interference with said plastically deformed ratchet to prevent movement of said plastically deformed ratchet from the at least one striker capture position to the striker release position during the crash condition.

3. The closure latch assembly of claim 2, wherein the ratchet has a roughened outer surface facing the first stop member, wherein the roughened outer surface enhances frictional engagement with the first stop member during the crash condition.

4. The closure latch assembly of claim 3, wherein the roughened outer surface is formed by a plurality of ribs extending along an outer periphery of the ratchet.

5. The closure latch assembly of claim 4, wherein the first stop member has a plurality of ribs configured for meshed engagement with the plurality of ribs of the ratchet to increase the friction between ratchet and the first stop member during the crash condition.

6. The closure latch assembly of claim 3, wherein the first stop member has a roughened outer surface facing the roughened outer surface of the ratchet, wherein the roughened outer surfaces of the ratchet and the first stop member engage one another to enhance frictional engagement with the first stop member during the crash condition.

7. The closure latch assembly of claim 2, wherein the at least one striker capture position includes a primary striker capture position and a second striker capture position, wherein said first stop member prevents movement of said plastically deformed ratchet from the primary striker capture position to the striker release position during the crash condition.

8. The closure latch assembly of claim 7, further including a second stop member fixed to said frame plate, said ratchet being configured to move in clearance relation with said second stop member when said ratchet moves from the secondary striker capture position to the striker release position during normal operation, wherein said second stop member is configured for interference with said plastically deformed ratchet to prevent movement of said plastically deformed ratchet from the secondary striker capture position to the striker release position during the crash condition.

9. The closure latch assembly of claim 8, wherein said second stop member is formed as a monolithic piece of material with said frame plate.

10. The closure latch assembly of claim 9, wherein said second stop member is formed as a tab of material bent from an outer periphery of frame plate.

11. The closure latch assembly of claim 1, wherein the ratchet has a ratchet pin opening configured for receipt of a ratchet pin therethrough, about which said ratchet pivots during normal operation, and a striker slot in which the striker is received while said ratchet is in the at least one striker capture positions, said striker slot being open to said ratchet pin opening.

12. The closure latch assembly of claim 2, further including a first ratchet guide member extending laterally from the first stop member, the first ratchet guide member inhibiting the ratchet from moving out of the pivot plane.

13. The closure latch assembly of claim 8, further including a second ratchet guide member extending laterally from the second stop member, the second ratchet guide member inhibiting the ratchet from moving out of the pivot plane.

14. The closure latch assembly of claim 3, wherein the ratchet has a striker slot in which the striker is received while said ratchet is in the at least one striker capture position, the roughened outer surface is located between the weakened outer surface and the striker slot.

15. A method of preventing a ratchet of a closure latch assembly of a motor vehicle closure panel from inadvertently moving about a pivot plane from at least one striker capture position to a striker release position during a crash condition, comprising:
configuring the ratchet having a weakened deformation region that causes the ratchet to be plastically deformed locally in the weakened deformation region during the crash condition, whereupon movement of the ratchet from the at least one striker capture position to the striker releasing position is prevented.

16. The method of claim 15, further including providing a first stop member fixed to a frame plate of the closure latch assembly, the ratchet being configured to move in clearance relation with the first stop member when the ratchet moves from the at least one striker capture position to the striker release position during normal operation, wherein the first stop member is configured for interference with the plastically deformed ratchet to prevent movement of the plastically deformed ratchet from the at least one striker capture position to the striker release position during the crash condition.

17. The method of claim 16, further including providing at least one of the ratchet and the first stop member having a roughened outer surface to enhance frictional engagement between the ratchet and the first stop member during the crash condition.

18. The method of claim 16, further including providing the at least one striker capture position including a primary striker capture position and a second striker capture position, wherein the first stop member prevents movement of the plastically deformed ratchet from the primary striker capture position to the striker release position during the crash condition, and further including providing a second stop member fixed to the frame plate, the ratchet being configured to move in clearance relation with the second stop member when the ratchet moves from the secondary striker capture position to the striker release position during normal operation, wherein the second stop member is configured for interference with the plastically deformed ratchet to prevent movement of the plastically deformed ratchet from the secondary striker capture position to the striker release position during the crash condition.

19. The method of claim 18, further including providing at least one of the ratchet and the second stop member having a roughened outer surface to enhance frictional engagement between the ratchet and the second stop member during the crash condition.

20. The method of claim 19, further including providing a ratchet guide member extending laterally from at least one of the first stop member and the second stop member, the ratchet guide member inhibiting the ratchet from moving out of the pivot plane.
